(19) United States
(12) Patent Application Publication
(10) Pub. No.: US 2024/0200519 A1
(43) Pub. Date: Jun. 20, 2024

(54) DISTRIBUTION CYLINDER

(71) Applicant: Edouard Manga, Yaounde (CM)

(72) Inventor: Edouard Manga, Yaounde (CM)

(21) Appl. No.: 18/317,945

(22) Filed: May 16, 2023

Related U.S. Application Data
(63) Continuation-in-part of application No. PCT/IB2021/053892, filed on May 7, 2021.

(30) Foreign Application Priority Data
Jan. 4, 2021 (OA) 2202100001

(51) Int. Cl. F02M 35/104; F01N 13/10; F02B 75/02; F02B 75/18; F02B 75/20

(52) U.S. Cl. CPC F02M 35/104; F01N 13/10; F02B 75/02; F02B 75/20; F02B 2075/027; F02B 2075/1816

(57) ABSTRACT

The distribution cylinder (CDM) is a simplified, efficient and rational concept for insertion, top sealing and gas evacuation, for a new transformation of the internal combustion engine. It enables the extraction of ninety percent of the components from the old standardized system, which is more than a century and a half old, and which, until now, have performed these vital functions with the known limitations described in this study. The CDM lightens the structure and functionality of the engine, allowing manufacturers to save materials, production time, maintenance and fuel. It allows for the creation of powerful, faster and less polluting engines. It recommends that the four-stroke engine be recalibrated, considerably improving its performance. Thus equipped, it would naturally run faster since it would be freed from the mechanical limitations of its more resistant valve cylinder version The adoption of the timing cylinder, combined with the modern techniques developed for powering today's internal combustion engine, lays the foundation for a new generation of competitive yet lighter and more compact engines. Their torque will not only be more available but also more flexible to serve all uses and all engine sizes.

### FIELD OF INVENTION

The present invention relates to the mode of introduction, high sealing, and evacuation of the gases in a four-stroke heat engine: the distribution cylinder.

### BACKGROUND

A distribution cylinder is a set of coordinated mechanical parts, whose purpose is to ensure in a cyclic way, the insertion into the engine of fuel (air) and fuel to keep tight this flow in the combustion chamber during compressions and then, to evacuate the burned gases after sometimes from engines. A modern four-cylinder engine has more than sixty essential parts for this purpose and a six-cylinder engine has more than a hundred.

In the mechanical components of which a classic engine is made up, the distribution cylinder is not only the most complex part, but also the one whose different modifications will have brought to the engine a notable evolution.

A large number of components work in motion, are subject to friction, and constitute larger resistances that weigh down the fluidity of the engine. It should be added that the intervention time that is allocated from the factory to the assembling, from factories to maintenance workshops of this part of the engine is considerably important. We observed all the manufacturers from the camshaft placed in the engine block and driven by large pinions, which controlled the lifting of the tappets. These lifting long rods went up to the cylinder head, then these rods actuated the pivoting of the rockers on an axis or two; rockers which finally ordered the opening of the valves long procedure now no longer applicable.

Closer, the engines equipped with header camshafts were somehow to modernize the distribution system, with the hydraulic play compensation plunger until now. From then to now, the four-valve-per-cylinder distribution is, in its turn, the privileged solution that almost all firms have adopted, it should also be noted that the recall spring in this conventional distribution has remained indispensable. More disturbing still, it has become 5 stiffer or even doubled; so that it ensures as quickly as possible, the return of the valve for the sealing, by pressing it sharply on its seat.

The components that make up the distribution cylinder of a modern four-cylinder engine are generally the following:
One or two camshafts
Sixteen tappets or rockers or both at the same time
Sixteen valves
Sixteen valve guides
sixteen return springs or thirty-two

An exhaust manifold and many accessories for the layout and mechanical convenience. It is in fact more than sixty parts, most of them in motion, which are thus manufactured and harmoniously adjusted. The goal is to ensure a better filling of the cylinders to be powered, to keep this rhythm until combustion, and thus improve the performance of our engines. Considering the reduction of material and consequently of weight, space, friction, resistance, and production costs.

Another type of lifting and closing of valves, which gives much better results to the extent of doubling its rotation speed, is the method designed by the engine manufacturers: pneumatic control. It eliminates the return spring and others, for the use of air pressure. In this process of well-known advanced technology, the engine loads are clearly reduced but given the complexity of the system and the high cost, this process since its discovery remains the prerogative of high-level motorsport. It is not a popular series, we think, for these reasons. The results obtained are as high as the efficiency and performance that our engines have achieved today.

We declare that: The compression of the valve return springs is the greatest resistance that weighs down the structure of an empty engine and during operation, the resistances are thus the main factors of the weak output; the above-mentioned parts within the lead the springs of return, are indeed these consumers needed in this distribution with valves like in other mechanics of the kind. The search for their reduction is one of the goals of this study, which would undoubtedly maximize the power returned to the crankshaft for use; a guarantee of better performance.

An additional and still disturbing factor imposed by this bygone distribution is that an additional and always annoying factor imposed by this old distribution is that, in order to increase the rotation speed of our engines, these springs are designed to be increasingly stiff, requiring an additional effort for their compression: “Paradox”!

A severe mechanical limitation is associated with it: in spite of this increased stiffness, the speed of rotation of the valve engines is limited much earlier; symbolized by the red area on the dashboards of our machines. The real reason is that these powerful springs always recall the valves to their seats at high speed. The valves thus run the risk of being overtaken by the pistons, which mechanically rise faster than the springs, which are always too slow.

The manufacturers are obliged then, shortly before this limit of self-destruction known by all, to break electronically under this mechanical constraint, the maximum rotation speed of their engines although unwillingly, let's call this third factor “Mechanical limit of the system”.

In short, it is this increased number of parts in the distribution of today's advanced engine that presents: not only a maximum of friction, resistance, increased risk of damage, breakdowns, congestion and time; but also early perceived mechanical limits justifying the low performance of all manufacturers, firms included, hence, the reason for our study.

We dare to question a universalized process, already more than a century and a half old and the general discontent foresees the premature withdrawal of production units in our opinion; due to lack of summation. Our contribution is an inherent step in the requirements of state-of-the-art technology in a constant quest for perfection.

### SUMMARY

The distribution cylinder (CDM) is a simplified, efficient, and rational concept for the introduction, top sealing and evacuation of gases, for a new mutation of the internal combustion engine. It allows the removal of ninety percent of the components from the old standardized system, which is more than a century and a half old, and which until now have performed these vital functions with the known limitations described in this study.

The CDM lightened the structure and functionality of the engine, allowing manufacturers to save on materials, production time, maintenance and fuel, and to create powerful, faster and less polluting engines.

He proposes that the four-stroke engine be recalibrated, considerably improving its efficiency. Thus equipped, it would naturally run faster since it would be free of the mechanical limitations of its more resistant valve counterpart.

The adoption of the timing cylinder, combined with the modern techniques developed to power today's internal combustion engine, lays the foundations for a new generation of competitive engines that are also lighter and more compact. Their torque will not only be more available but also more flexible to serve all purposes and all engine sizes.

The rationality of this theoretical approach undoubtedly presages unequal performance connections of all kinds from the first mounting.

We propose in this basic study, a single part per cylinder line in the first version, and two parts for the second. These parts of simple but precise design, should better ensure the distribution of the next engines to the point of improving their performances and better, increasing considerably their output like never before. These are the mixed timing cylinder, and the separate and exhaust cylinders. We abbreviate this name with three letters: CDM.

The principle we propose to manufacturers in this study is basic, simple and essentially modular. The range of diversification of this engine will be wide to satisfy all the uses and for all the distinct cylinders; from the single cylinder fifty cubic centimeters for kids' scooters to the engines of motorbikes of all types, gliders, cars of all ranges including sports cars, trucks, public works machines, trains and even ships, all fuels included.

It is a large hollow cylinder with sufficiently thick walls. Its exterior is meticulously polished. After the study on the choice of the adequate materials which will have to answer the thermal and wear constraints. It will have to withstand without deformation the temperatures as high as in a traditional combustion chamber, and the engine compressions that it will undergo. The alloy that structures this vital part must remain stable. We thought of an anti-wear treatment on the surface of a titanium cylinder.

This large cylinder will have two oblong holes cut at 45° in each section, one for the intake and the other for the exhaust. The gap between the two ports of the same section is also 45° and each section will be exactly aligned with each piston head.

The distribution cylinder will receive from the inside a thick and totally watertight partition, which will arrange the intake port and the exhaust port in the same compartment. This arrangement will be established over the whole length of the CDM and for the system to be logically functional, the intake compartment will be plugged at the rear and the exhaust compartment will be plugged at the front. It is these 45° spaced ports that will cyclically yawn in front of a 45° open access space above the pistons, which will allow the intake and exhaust of gases. The angle of the oblong orifice and that of the access space will both be a theoretical 90°; thus covering each of the two opening and closing strokes on the four known engine strokes engines, just as the valve openings of conventional engines do (FIG. 7).

The angles given here are theoretical. On the other hand, practically speaking, the intake opening delays (AOC), the exhaust closing delays (RFE) and the advanced exhaust opening (MOE) and then the intake closing delay (RLA) will be taken into account to optimize engine performance, according to the requirements of the different uses for which the engine is built.

The distribution cylinder will replace the gas inlet and outlet manifolds because all intakes will be through the front opening of the CDM, and all exhausts through the rear regardless of the number of engine cylinders on the same line. The whole system will be carefully balanced for high-speed rotation before mounting. This will be the mixed cylinder; it will be attached to the cylinder head in an eccentric manner: about 30° to the axis of the pistons. The CDM will rotate on bearings at the speed of one revolution for every two revolutions of the crankshaft, just like the camshafts of conventional engines. In its mounting and rotation, it grazes the seat that protects it without touching it. A single bearing will cover its entire length.

The second version will have two separate cylinders. The first one will receive only the intake ports and will assume only this function, and the second cylinder will obviously receive a sealing ring for each oblong port operated on each CDM. Various types of internal separation of the mixed distribution cylinder are shown; the most complex (FIG. 7). They all correspond to the principle we described, and several other developments can be made at the discretion of the designers. Below are some we have named some of them:
Sinusoidal blade cylinder
Molded wall cylinder
Recessed pipe cylinder.

Based on the shape of the latter, we thought of a type of turbine that offered a double benefit because, the body of our turbine being rotary, will carry fixed blades or stators. We will call it: “integrated turbine or Turbo-i”. The simple concept will be more efficient for this reason. We will explain the principle again later, as well as its application to the new four-stroke combustion engine of the CDM version.

The weight reduction and material savings are now not just in the distribution components but to that vital piece of privilege equipment which here gets rid of the massive cast iron body that protects the classic turbines, and more. In order to see the distribution cylinder (CDM) in its two versions and for the system to be fully functional, a redesign of the cylinder head is necessary.

The new cylinder head will now be hollowed out at the top and along its length, with one or two semi-circular channels of exactly 180° degrees for each version so that from these semi-circles, the cylinder heads can still be seen through the access space created and described above at 45° angle. It is in these rounded channels that the distribution cylinders of both versions will be placed. (See FIG. 2).

Taking it over; it will be operated on the parting line, exactly at the places where the pistons go up, as many holes opening into these channels as there are engine cylinders of the same diameter. These openings in the cylinder head will thus be the extension of the engine cylinders so that when the cylinder head is placed on its block, the heads of the pistons will continue to be visible and will then slightly exceed the finished height of the engine block. This slight offset of the pistons just before the first ring will fit into our new cylinder head. The distribution cylinder will touch the heads of the pistons in TDC position without touching them, the remaining space between these two parts will be just right, and will constitute the “combustion chamber” of this double cylinder version (See FIG. 2).

On the other hand, the option of mixed cylinder in our concept will receive a lip on the engine block going up here on the left. This will be either integral or bolted depending on convenience. On the opposite side, a specially designed spacer will carry spark plugs or injectors on its outside. Its interior will also be calibrated to create a combustion chamber. The lever and spacer will form a semi-circle of exactly 180º. (See FIGS. 1 and 6).

The shape of the gas orifices:

These orifices around the CDM will be oblong, we say. The length will be arranged in the same direction as that of the distribution cylinder itself. While the rounding of the ends will be almost equal to the diameter of the engine cylinder to be powered.

The width will occupy an angle of 45° which, added to the angle of the access port, will make a theoretical 90° degrees as described above (see FIGS. 3 and 6) this will be the case for all openings.

### BRIEF DESCRIPTION OF THE DRAWINGS

FIG. 1—Exploded view of the engine equipped with the (mixed CDM).

FIG. 2—Cross-section of the engine equipped with two distinct cylinders.

FIG. 3—Comparison of the air inlets offered by the oblong holes of the CDM in relation to the valves.

FIG. 4—Different views of the curved sealing ring.

FIG. 5—4-stroke materialization in 2d and representing the four-stroke engine.

FIG. 6—Different types of mixed CDM

FIG. 7—Perceived angular division of the four strokes, angles of the ports, angles of the access spaces and spaces between ports: all 45°

FIG. 8—3d presentation sketch of our prototype with integrated turbine.

### DETAILED DESCRIPTION

The multiplication of valves in a distribution system is intended to facilitate better filling of the cylinders: by observing by way of illustrating the space offered by the orifice of a CDM that leaks in front of the cylinder it supplies, we can conclude that with this new system, the filling and advantages achieved go far beyond the two valves that comes largely above the two valves serving the same purpose (See FIG. 20).

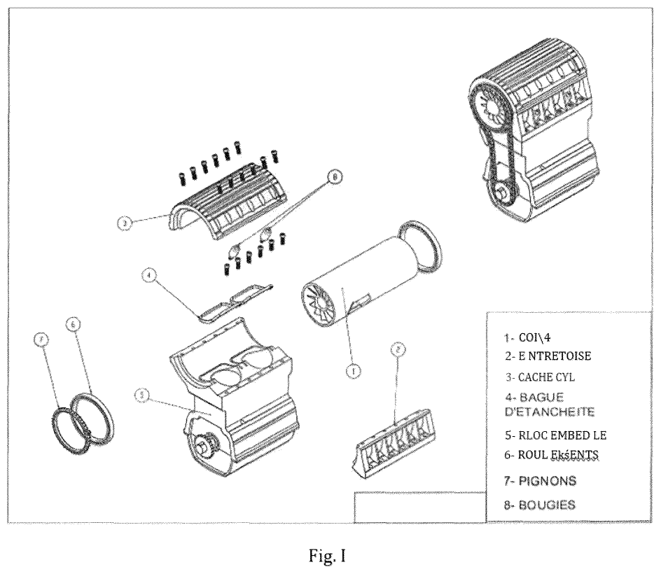

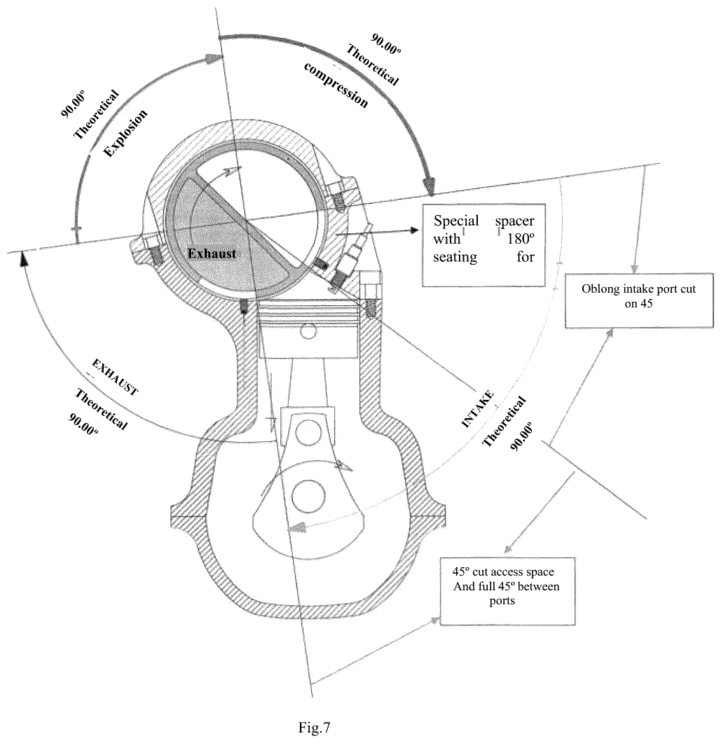

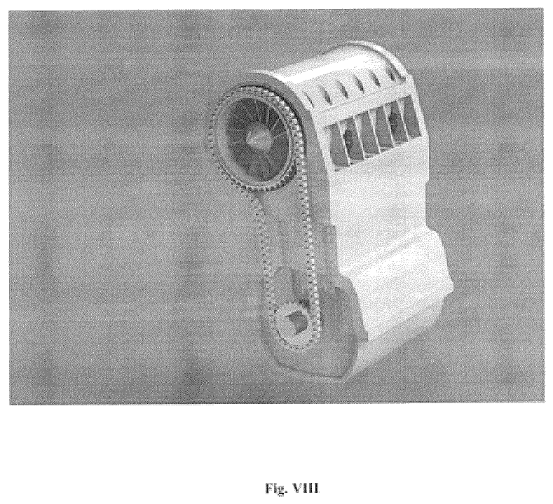

Note: It has been said in the summary description that the mixed CDM will be mounted in an offset manner. This eccentricity of CDM on the cylinder that it supplies and evacuates is foreseen, in order to leave an access from outside in the combustion chamber; which will be able to receive the spark plugs, those of preheating or the injectors in diesel version. The special spacer described above compensates for this space. (See FIGS. 1 and 7). The version of the separate cylinders receiving without inconvenience these vital accessories in its middle part.

### Sealing of the Compressions:

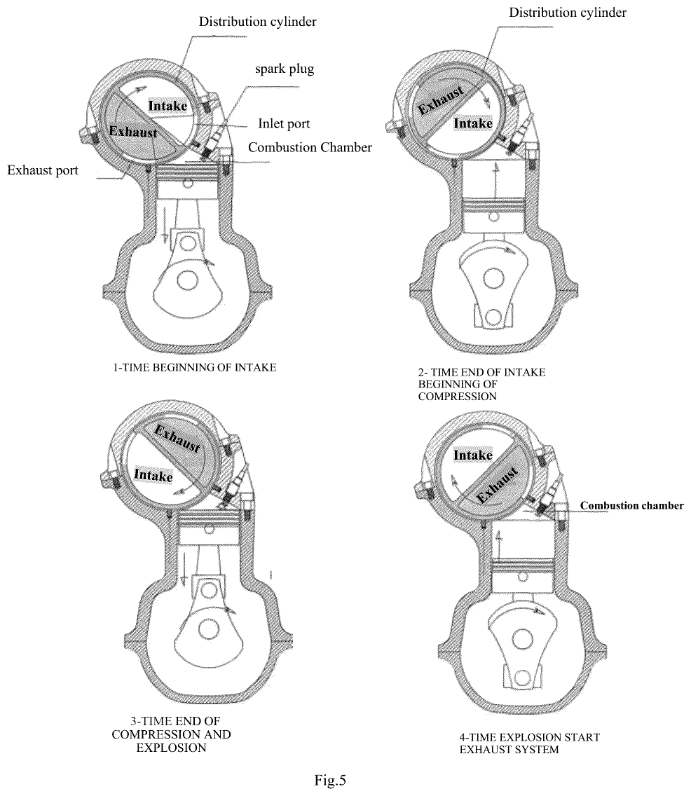

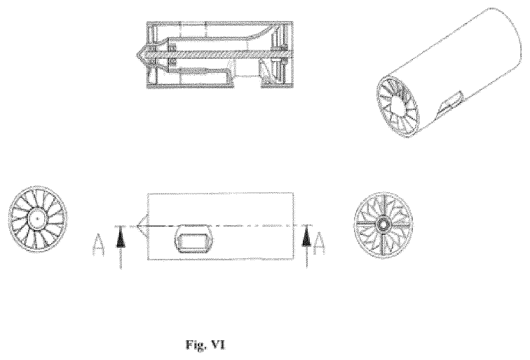

A curved ring of rectangular section, whose contour will surround your combustion chamber will be designed in suitable material, (See FIG. 4) this closed ring will be housed this closed ring will be housed in a groove whose precise shaping will loop from the outside, said chamber. It will be kept in contact with the CDM first by weak spring blades at a standstill; then by oil pressure, coming out of the lubrication holes provided for this purpose from the bottom of the said housing. The ring, with this calibrated pressure, will scrape the outside of the distribution cylinder. The correct and lapped contact of the two surfaces:

CDM and the ring resolutely prevents compression leaks.

This original and simple sealing system will be very effective.

### How it Operates:

The engine equipped with cylinder timing has no difference in operation, compared to its counterpart with valves.

The intake port is synchronized with the first descent of the piston, as is the air intake valve. At the time of the first rise of the piston corresponding to the compression, the full part of the CDM closes the fire chamber sealed by the curved ring for the explosion. Then finally the evacuation orifice opens for the fourth time and the cycle can start again. (See plate of the abstract is descriptive).

The variable timing, turbines and air compressors continue to justify their contribution to the overcharging.

### The Integrated Turbine:

The concept is that of a turbojet engine, (See FIG. 8).

The air flow enters from the front, sucked in by one or more compressor rotors, fixed on the same axis on which the rear driving propeller is fixed. The orientation of the blades is studied so that the exhaust gases leave from the rear, dragging the unit. The more the said gases rush out onto the rear driving blades, the more the boost pressure increases by driving the compressor. A regulating valve allows the pressure to be modulated according to need. However, the rotation of the body, support of the system (CDM) offers us the opportunity to accelerate the air molecules on the rotor. It will be enough to fix blades integral with the said body and oriented in favor of the upstream rotor. These blades will apply a pre-compression of air on the rotor placed just behind them to obtain a much shorter filling time. This results in even sharper, faster and more efficient recovery, faster than a conventional fixed-body turbine.

The big competition will find useful elements to be put forward. We present (FIG. 8) a three-dimensional sketch of our prototype engine with mixed CDM.

Not only has it been stripped of all the distribution accessories already mentioned in this description, including the intake and exhaust manifolds, but we have also removed the cylinder head for two 180° rising lips. The concept is even lighter, and logically functional, compact and economical.

The compactness offered here allows small cylinders, which consume a lot of hydrocarbons, to benefit from the advantages of supercharging (motorcycles and others).

Another advantage, not less significant, is the recycling of burnt gases, which is practiced by almost all designers. 1 It becomes an internal process that will not necessarily require external accessories.

The management of temperatures around the CDM is essential and technically controllable. We thought of a mixed cooling; air/water; (see the sketch of our prototype FIG. 8). Taking into account the above, it is obvious that its mode of drive is done by a chain called of distribution chain.

The engines are all energy converters. The efficiency of the four-stroke engine remains low and researchers continue to work on improving it. Our study is intended to be to increase it by a few good points while avoiding to make it more expensive or cumbersome.

1. The distribution cylinder (CDM) is made of a thick metal tube, carefully polished from the outside for a hollow interior, and is sectioned into as many engine cylinders as it feeds and discharges, characterized in that each of its sections has two oblong orifices operating on 45° theory; a first port for the gas intake and a second for the exhaust, an internal and tight partition separates the intake ports from those of the exhaust over the whole length of the CDM, the intake cover of this partition is at the behind, while the exhaust compartment is rather closed at the front, in relation to the axis of the piston, the CDM is fixed eccentrically in a groove of 180° (degrees) formed, by a lip that goes up the engine block and completed by the special spacer that carries the spark plug or injector; It rotates on a bearing at the speed of one revolution for every two revolutions of the crankshaft, grazing its seat without touching it, a thick cover covers its entire length.

2. Distribution cylinder according to claim 1 the orifices are oblong in shape, their opening angle on the axis of the distribution cylinder is 45° degrees, combined with the access space above the piston, in front of which the orifices of 45° degrees yawn so that their crossing respects the theoretical cycle of the four strokes and closes at the end of the stroke of the piston concerned; that is to say on a rotation of 90° degrees theoretical; (FIG. VII) in practice the modifications related to it, that is to say AOA, RFA and AOE, RFF. can be realized at the time of optimization of the performances, the CDM rotates on bearings driven by a chain, at the speed of a whole for two rotations of the crankshaft, gazing its seat without touching it.

3. A distribution cylinder according to claim 1, wherein the air inlet of the whole cylinder line to be filled is single from the inlet of the distribution cylinder, the outlet of the burnt gases towards the back is also single; thus eliminating your conventional manifolds; said distribution cylinder acting as an intake and exhaust manifold.

4. Distribution cylinder according to claim 1, characterized in that the sealing of the compressions is conceived for each fire chamber by making a closed and curved box of rectangular cross-section, the curvature perfectly matching the external shape of the outer curve of the distribution cylinder,
this ring is housed in a deep groove that loops the combustion chamber; thus adjusted and lapped, the said ring is maintained in contact with the distribution cylinder first by small spring blades previously placed below the said grooves, then pushed by calibrated oil pressure coming from the lubrication holes.
this pressure of the ring in contact with the external body of the CDM ensures the total sealing of the compressions.

5. The distribution cylinder according to claim 1, is characterized by the fact that the body of the CDM on which the blades are fixed is rotable; the front blades of the rotor, oriented in the opposite direction to the blades, increase the air speed tenfold and thus improve the filling time of the cylinders to be fed; the interior of the CDM, which easily houses the compressor and propeller blades rotating on the same axis, thus offers filling without external obstruction to the entire line of engine cylinders thus equipped, from the smallest to the largest cylinders to the whole line of engine cylinders, from the smallest to the largest cylinders; this equipment gives the engines even more rapid acceleration; an exhaust valve regulates the pressure during pressure during the toning process.

6. A distribution cylinder according to claim 1, characterized in that it is provided with a tube rotating on bearings without risk of percussion by any other proximity element in its normal operation, not constituting any mechanism limiting its extension, thus allowing an increase in the speed of rotation of the engine thus equipped.

7. The distribution cylinder according to claim 1, is characterized in that it gathers in itself all the distribution organs, that the latter rotates on bearings scraped only by the special curved rings for the sealing with very low resistance, we estimate that less than 5% of the frictional resistance produced by the CDM distribution compared to the valve distribution; the more than 95% of resistance recovered (by the extraction of the valve return springs and others) is returned to the vehicle in terms of energy recovered, giving a clear increase in engine efficiency. The consumption of hydrocarbons is reduced, thereby reducing the pollution rate.

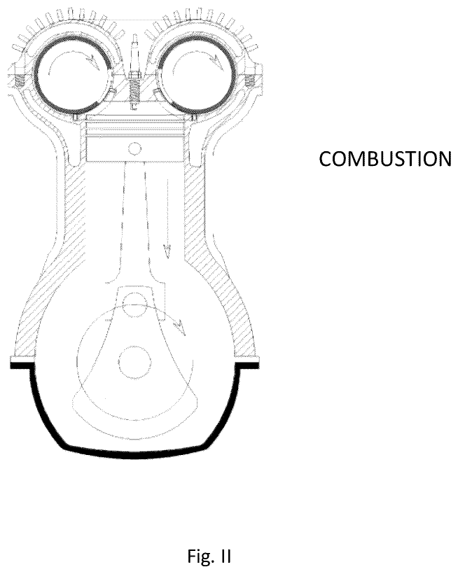

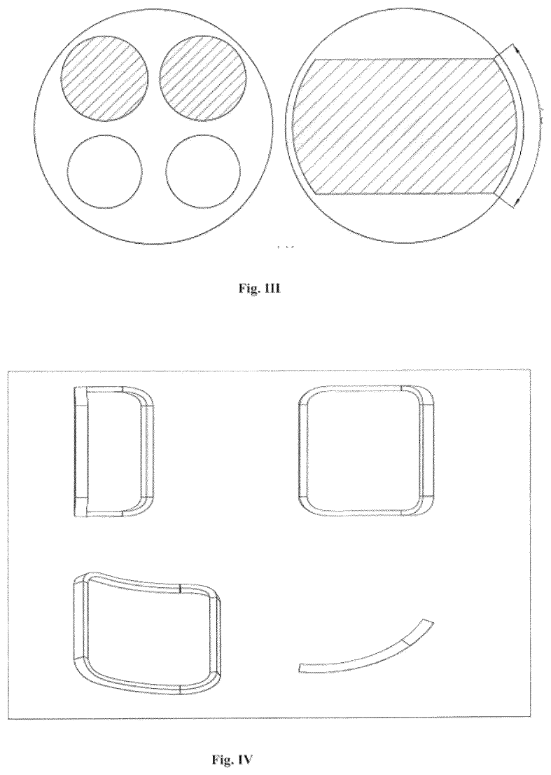

8. Distribution cylinder according to claim number 1. characterized in that it includes a specially designed spacer which completes the 180° (degrees) seating to receive the CDM on its eccentricity, this spacer fitting here on the right flank on our diagram of FIG. 2, constituting a part of the combustion chamber on its inside and its outside offering space for spark plugs or injectors.

9. Distribution cylinder according to claim 2. comprising two distinct distribution cylinders; the first one for the intake having only intake ports identical to those of the mixed CDM; the second one having the exhaust ports; this version without internal separation, receives a special curved ring for sealing by oblong port, each section being formed by an intake port coming from the first cylinder and a second port aligned to the first one and established on the exhaust cylinder, placed at the service of the same engine cylinder.

10. A single-piece distribution system per cylinder line for a four-stroke internal combustion engine according to claim 1, characterized by a part (the CDM) rationally fulfilling all the distribution functions; of a volume and weight defined according to the cubic capacity, the said part being fitted inside the engine, free of manifolds, thus generating more materials for its construction and saving time for mounting, thereby producing more compact engines.
